(19) United States
(12) Patent Application Publication
(10) Pub. No.: US 2007/0148591 A1
(43) Pub. Date: Jun. 28, 2007

(54) Pattern and wiring pattern and processes for producing them

(76) Inventor: Tatsuro Nagahara, Kakegawa-shi (JP)

Correspondence Address: AZ ELECTRONIC MATERIALS USA CORP.;Industrial Property Department, 70 Meister Avenue, Somerville, NJ, 08876, US

(21) Appl. No.: 11/640,748

(22) Filed: Dec. 18, 2006

(30) Foreign Application Priority Data
Dec. 28, 2005 (JP) JP 2005-379508

(51) Int. Cl. G03C 1/00

(52) U.S. Cl. 430/270.1

(57) ABSTRACT

This invention provides a process for producing a pattern, which can produce a semiconductor device or a display device at low cost, and a pattern produced by the production process. In the present invention, a highly lyophobic surface covering layer is formed on a photosensitive resin composition layer formed on a substrate, and a pattern is formed. The surface covering layer, which remains unremoved on the substrate, is highly lyophobic while the covering-removed part has relatively high lyophilicity. Accordingly, an electrically conductive material-containing composition can be selectively deposited on the covering-removed part, and a desired wiring pattern can be provided.

### BACKGROUND OF THE INVENTION

1. Field of the Invention

The present invention relates to a semiconductor device and a display device, and processes for producing them. More particularly, the present invention relates to a semiconductor device and a display device, in which a lyophilic part and a lyophobic part are formed on a surface of a substrate as a base and a wiring material is deposited only on the lyophilic part to form wiring, and processes for producing them.

2. Background Art

Wiring patterns for use in semiconductor devices or display devices have hitherto been generally produced by a method using a photolithographic process. This method generally comprises the steps of
(1) forming an electrically conductive film on a substrate,
(2) coating a photoresist on an electrically conductive film and forming a pattern by a photolithographic process,
(3) etching the electrically conductive film through the formed pattern (photoresist film), and
(4) removing the photoresist.

There is an increasing demand for higher-performance semiconductor devices and display devices. This demand has led to a demand for higher fineness and higher integration density for the structure of the semiconductor devices and display devices. Accordingly, expensive sputtering devices and etching devices for use in the production of these devices, which can perform a higher level of control, have become required. Specifically, in the step of forming an electrically conductive film, in the case of the formation of the electrically conductive film by a vapor phase process, a sputtering device or a CVD device is necessary, and, in the step of etching the electrically conductive film, an etching device is necessary. These necessities as such means an increase in equipment cost.

To overcome this drawback, studies have been made on a method for producing semiconductor devices and display devices at lower cost. One of such methods is disclosed in Japanese Patent Laid-Open No. 210081/2005. In this method, after the formation of a pattern on a substrate, the concave part is filled with metal material-containing liquid droplets by a droplet delivery method to form an embedded wiring. This method can advantageously eliminate the need to use expensive sputtering device and etching device.

According to studies conducted by the present inventors, however, it was found that the method described in Japanese Patent Laid-Open No. 210081/2005 is disadvantageous in that the accuracy of the droplet delivery method is important and should be high and, thus, there is room for improvement in equipment cost and production yield.

### SUMMARY OF THE INVENTION

In view of the above problems of the prior art, an object of the present invention is to provide a process for producing semiconductor device or a display device that is low in cost and has satisfactory performance.

According to one aspect of the present invention, there is provided a pattern comprising

a substrate,

a photosensitive resin composition layer formed on said substrate, and

a surface covering layer formed on said photosensitive resin composition layer, said photosensitive resin composition layer and said surface covering layer having been removed imagewise,

wherein the contact angle of n-hexadecane with said surface covering layer as measured at 23° C. is not less than 41 degrees.

According to another aspect of the present invention, there is provided a method for wiring pattern formation comprises the steps of:

forming a photosensitive resin composition layer on a substrate;

forming a surface covering layer on said photosensitive resin composition layer;

exposing said photosensitive resin composition layer imagewise; and

developing the assembly to remove said photosensitive resin composition layer and said surface covering layer in their exposed areas,

wherein the contact angle of n-hexadecane with said surface covering layer as measured at 23° C. is not less than 41 degrees.

According to still another aspect of the present invention, there is provided a method for wiring pattern fabrication comprises the steps of:

forming a photosensitive resin composition layer on a substrate;

forming a surface covering layer on said photosensitive resin composition layer;

exposing said photosensitive resin composition layer imagewise;

developing the assembly to remove said photosensitive resin composition layer and said surface covering layer in their exposed areas; and

depositing an electrically conductive material-containing composition only on the part from which the covering has been removed by the development,

wherein the contact angle of said electrically conductive material-containing composition with the surface covering layer as measured at 23° C. is not less than 41 degrees.

According to a further aspect of the present invention, there is provided a semiconductor device comprising a wiring pattern, said wiring pattern has been produced by a method comprising the steps of:

forming a photosensitive resin composition layer on a substrate;

forming a surface covering layer on said photosensitive resin composition layer;

exposing said photosensitive resin composition layer imagewise;

developing the assembly to remove said photosensitive resin composition layer and said surface covering layer in their exposed areas; and

depositing an electrically conductive material-containing composition only on the part from which the covering has been removed by the development,

wherein the contact angle of said electrically conductive material-containing composition with said surface covering layer as measured at 23° C. is not less than 41 degrees.

According to the present invention, a contrast between a higher affinity part and a lower affinity part for a liquid can be formed on a substrate, whereby a liquid can be deposited on a surface of the substrate only in its desired position. By virtue of this effect, a wiring pattern can be formed by depositing an electrically conductive liquid on the surface of a substrate. According to this method, a semiconductor device and a display device can be produced at low cost. Further, the necessity of enhancing the delivery accuracy of the electrically conductive liquid is lowered. Accordingly, the semiconductor device and the display device can easily be produced, and the cost of the production apparatus can be reduced.

### BRIEF DESCRIPTION OF THE DRAWINGS

FIG. 1 is a diagram illustrating a method for pattern formation according to the present invention,

FIG. 2 is a cross-sectional view of an embodiment of a pattern according to the present invention,

FIG. 3 is a cross-sectional view showing a process for producing a wiring pattern according to the present invention,

FIG. 4 is a three-dimensional cross-sectional view showing an embodiment of a pattern according to the present invention, and

FIG. 5 is a top view showing an embodiment of the shape of a pattern according to the present invention.

### DETAILED DESCRIPTION OF THE INVENTION

The method for pattern formation according to the present invention will be described with reference to the accompanying drawings.

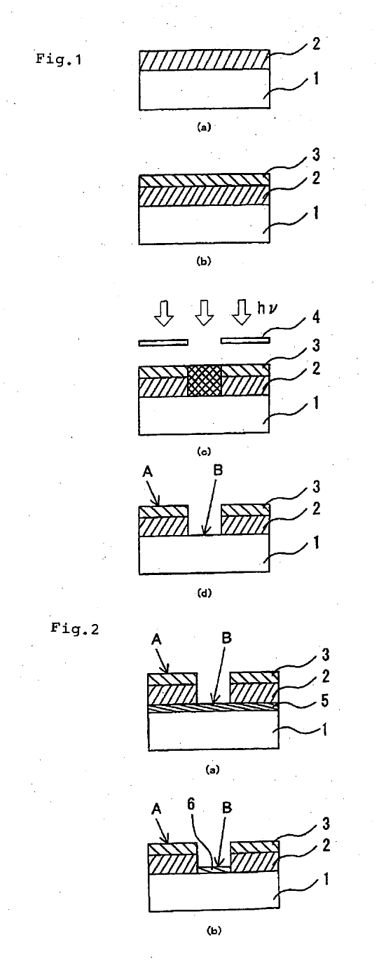

FIG. 1 shows an embodiment of a method for pattern formation according to the present invention. A photosensitive resin composition layer is first formed on a substrate 1 (FIG. 1(a)). In this case, any substrate may be used, and examples thereof include glass, semiconductor materials such as Si or GaAs. Further, prior to the formation of the photosensitive resin composition layer, the substrate may be pretreated, for example, by surface polishing, or alternatively may be covered with a material having high affinity for an electrically conductive material-containing liquid which will be described later, in other words, a lyophilic material.

A photosensitive resin composition layer 2 is formed on the surface of the substrate 1. The photosensitive resin composition layer 2 may be any desired one. The photosensitive resin composition layer 2 is generally formed by coating a photosensitive resin composition comprising a polymer, a photosensitive agent, and a solvent onto a substrate 1. The components contained in the photosensitive resin composition may be properly selected, for example, according to the type of the contemplated device and pattern. Polymers usable herein include polymers having a silazane structure, acrylic polymers, silanolsilicones, and polyimides. The photosensitive agent may be properly selected, for example, according to the type of polymer to be used in combination with the photosensitive agent, a light source used in the exposure and the like. Specific examples thereof include naphthoquinonediazide-containing compounds, triphenylsulfonium compounds, diphenyliodonium compounds, and triazine compounds. The solvent is selected from those that can homogeneously dissolve or disperse the above polymer and photosensitive agent. Specific examples thereof include propylene glycol monomethyl ether acetate, propylene glycol monomethyl ether, butyl acetate, xylene, toluene, nonane, and nonyl alcohol.

Among these photosensitive resin compositions, those containing a polymer having a silazane structure are preferred. Photosensitive polysilazane compositions usable in the present invention include those described, for example, in Japanese Patent Laid-Open No. 311591/2000. The silazane structure in the polymer can advantageously enhance heat resistance and visible light transmittance and lower the dielectric constant. For example, PS-MSZ (a composition comprising a photoacid generating agent added to methylsilazane, manufactured by AZ Electronic Materials) may be used in the photosensitive resin composition.

The photosensitive resin composition layer 2 is generally coated in a liquid state. The photosensitive resin composition is coated by any desired method, for example, a method selected from spin coating, dip coating, spray coating, and slit coating.

The photosensitive resin composition layer 2 after coating is if necessary heated for solvent removal and/or composition layer curing. This heating is generally called “prebaking.” Conditions for prebaking vary depending, for example, upon the type of the photosensitive resin composition used. The prebaking, however, may be carried out generally at 40 to 150 ° C., preferably 60 to 140 ° C., generally for 0.5 to 10 min, preferably 1 to 3 min.

The thickness of the photosensitive resin composition layer 2 is not particularly limited. In general, however, the thickness is 0.01 to 100 μm and may be selected depending upon the application of the pattern.

Next, a surface covering layer 3 is formed on the photosensitive resin composition layer (FIG. 1(b)). The surface covering layer 3 should be repellent to organic solvents and surfactant-containing aqueous solutions. In the present invention, the contact angle of n-hexadecane with the surface covering layer 3 should be not less than 41 degrees, preferably not less than 50 degrees. Accordingly, upon contact with this layer, the solvent and the like are repelled by the layer. Here the contact angle of n-hexadecane is a general index indicating liquid repellency of the surface of the material. In the surface covering layer in the present invention, that the contact angle of n-hexadecane with the surface covering layer is not less than 41 degrees, shows that the covering layer is repellent to generally used organic solvents or surfactant-containing aqueous solutions. This surface covering layer 3 can be realized, for example, by a fluoropolymer-containing film.

The fluoropolymer layer is generally formed by coating a composition comprising a fluoropolymer dissolved or dispersed in a solvent. The fluoropolymer usable herein may be any fluoropolymer so far as the contact angle of n-hexadecane or an electrically conductive material-containing composition, which will be described later, with the fluoropolymer layer falls within the range specified in the present invention. Such fluoropolymes include alkanes, alkenes, alkyl ethers, and alkanols, containing, for example, perfluoroalkyl or perfluoroalkoxy groups having 1 to 18 carbon atoms, for example, perfluoroalkanes or perfluoroalkoxyalkanes. They may if necessary contain a halogen other than fluorine. More specific examples thereof include tetrafluoroethylene, chlorotrifluoroethylene, and ethylenetetrafluoroethylene copolymer. Solvents usable for dissolving or dispersing these polymers include hydrofluoroether. The composition containing the fluoropolymer may if necessary contain other additives, for example, surfactants, colorants, binders, dispersants, pH adjustors, viscosity modifiers, and catalysts for baking. Further, a commercially available composition, for example, FS-1010 (manufactured by Fluoro Technology), may also be used as the fluoropolymer-containing composition. The fluoropolymer-containing composition may be coated by any desired method.

If necessary, the solvent is removed from the surface covering layer 3 after coating by heating or the like. This step may be carried out in conjunction with the prebaking of the photosensitive resin composition layer 2. Specifically, a method may also be adopted in which the surface covering layer 3 is coated by a “wet-on-wet” method in a period between after coating of the photosensitive resin composition layer 2 and before heating and the two layers are simultaneously heated and cured.

The surface covering layer 3 thus formed may have any thickness so far as it can cover the photosensitive resin composition layer 2 and, as described above, can render the surface lyophobic. In general, however, the thickness of the surface covering layer is set to not more than 1 μm, preferably not more than 0.5 μm, more preferably not more than 0.1 μm, from the viewpoints of evenly covering the photosensitive resin composition layer 2 and easily removing the covering layer 3 together with the photosensitive resin composition layer 2 in the step of development which will be described later. On the other hand, the thickness of the surface covering layer 3 is preferably not less than 0.001 μm from the viewpoint of satisfactory liquid repellency of the surface covering layer.

The substrate 1 with the photosensitive resin composition layer 2 and the surface covering layer 3 (the photosensitive resin composition layer 2 and the surface covering layer 3 being hereinafter often collectively referred to as “covering layer”) formed thereon is then exposed imagewise (FIG. 1(c)). Methods usable for imagewise exposure include a method as shown in FIG. 1(c) in which exposure is carried out through a mask 4, and a method using a stepper, and a method in which scanning exposure is carried out. The photosensitive resin composition layer in its area exposed in the step of exposure has increased solubility in a developing solution.

The exposed photosensitive resin composition layer 2 is then developed. The developing solution is selected depending upon the photosensitive resin composition used. Alkaline aqueous solutions, for example, an aqueous tetramethylammonium hydroxide solution, an aqueous sodium hydroxide solution, and an aqueous potassium hydroxide solution, are generally used. The development is if necessary followed by drying. Thus, a pattern according to the present invention is produced. In the pattern thus obtained in its part where the surface covering layer has been removed, the substrate surface is exposed, or alternatively, when the substrate surface is covered with a lyophilic material, the lyophilic material layer is exposed. This part has relatively higher lyophilicity than the surface covering layer. Specifically, in general, the lower the contact angle of n-hexadecane with this part, the more preferable. More specifically, the contact angle is preferably not more than 40 degrees.

When a polymer having a silazane structure is used as the photosensitive resin composition, the photosensitive resin composition layer after the pattern formation may be exposed and humidified. This treatment is advantageous in that an acid is produced in the photosensitive resin composition layer in its exposed part, the Si—N bond in the polysilazane is cleaved by the produced acid, and the cleaved product is reacted with moisture in the atmosphere to give a silanol. As a result, the conversion of the polymer having a silazane structure to a siliceous film can be advantageously promoted.

In the above embodiment, the photosensitive resin composition layer 2 is formed, and, before exposure, the surface covering layer 3 is formed. In order to attain the effect of the present invention, carrying out these steps in this order is not always required. Specifically, the surface covering layer may be formed in any point of time between after the formation of the photosensitive resin composition layer and before the development. For example, the surface covering layer may be formed after the exposure.

Further, in the above embodiment, the so-called “positive-working photosensitive resin composition” is used. However, the pattern can be formed also when a negative-working photosensitive resin composition is used. In this case, as in the general case where a pattern is formed using a negative-working photosensitive resin composition, a pattern in which a covering layer remains in the exposed part is formed.

If necessary, other layers may also be formed. For example, an intermediate layer may be provided between the photosensitive resin composition layer and the surface covering layer or between the substrate and the photosensitive resin composition layer. In particular, the provision, on a substrate, of a layer 5 having high affinity for a photosensitive resin composition which will be described later, that is, a layer 5, which is formed of a highly lyophilic material and is not removed by the development, increases the difference in lyophilicity between the surface of the surface covering layer and the covering layer-removed part and is advantageous for the deposition of the electrically conductive material-containing composition on the highly lyophilic part (FIG. 2(a)). The same effect can be attained by forming, after the development, a highly lyophilic material layer 6 on the covering layer-removed part (FIG. 2(b)).

Further, the surface state of the covering layer-removed part may be regulated to improve the adhesion of an electrically conductive material-containing material which will be described later. Such methods include an ultraviolet irradiation method, plasma treatment, and hydrofluoric acid treatment.

The production process of a wiring pattern according to the present invention includes the step of further depositing an electrically conductive material on the pattern, formed by the above process, in its desired position, that is, the covering layer-removed part.

A dispersion liquid containing electrically conductive metal fine particles or the like dispersed therein may be mentioned as the electrically conductive material-containing composition. Since the contact angle of n-hexadecane with the surface covering layer in the present invention is not less than 41 degrees, the surface covering layer is highly repellent to commonly used organic solvents and surfactant-containing aqueous solutions. A composition containing any desired medium can be used except for exceptional circumstances. Since, however, the affinity for the covering layer-removed part, that is, the part onto which the electrically conductive material-containing composition is to be deposited is preferably high, a composition containing a proper medium should be used. Further, the composition should not unnecessarily dissolve the formed covering layer and the like.

Examples of such electrically conductive material-containing compositions include those prepared by dispersing electrically conductive particles of copper, silver, gold, nickel, zinc, graphite or the like as an electrically conductive material, in an organic solvent such as n-hexadecane, decane, propyl alcohol, toluene, xylene, methyl ethyl ketone, dioctylamine, octane, or dimethyl phthalate, or a surfactant-containing water. When water is used as the medium, a surfactant-containing aqueous solution is generally used. Surfactants usable herein include sodium laurylate, ammonium laurylate, lauryl alcohol sulfuric ester ammonium, sodium alkylbenzenesulfonate, alkylamine oxide, lauryldimethylbetain, and polyethylene glycol monolaurate. Among them, copper- or silver-containing surfactants are particularly preferred, because the resistance of the wiring circuit is lowered. The electrically conductive material-containing composition may if necessary contain various components. However, the contact angle of the composition with the surface covering layer as measured at 23° C. should be not less than 41 degrees, preferably not less than 50 degrees.

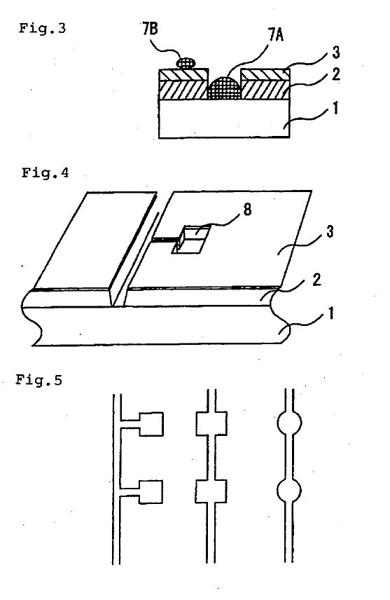

The electrically conductive material-containing composition may be deposited on the above pattern by any desired method. For example, the electrically conductive material-containing composition may be coated onto the whole area of the substrate, for example, by spin coating, dip coating, spray coating, or slit coating. Upon coating, the electrically conductive material becomes ball-like shape in the highly lyophobic part, that is, on the surface covering layer, while the electrically conductive material is deposited on the highly lyophilic part, that is, on the covering layer-removed part. This state is as shown in FIG. 3. That is, the electrically conductive material-containing composition is deposited on the covering layer-removed part, that is, on the groove part in the formed pattern (7A), while the remaining electrically conductive material-containing composition is lyophobic and thus became ball-like shape on the surface covering layer (7B). The electrically conductive material-containing composition in the ball shape can easily be removed from the surface of the substrate by inclining the substrate, applying centrifugal force, or spraying an air stream. As a result, the electrically conductive material composition is deposited only on the covering layer-removed part on the substrate.

Alternatively, the electrically conductive material may be disposed only on the covering layer-removed part rather than the whole area coating. Specifically, when an electrically conductive material-containing composition is supplied to the covering layer-removed part, for example, by using a dispenser, the electrically conductive material is developed into the covering layer-removed part connected to the dispenser or the like. Since the part where the covering layer remains unremoved is covered with the surface covering layer, there is no possibility that the electrically conductive material-containing composition overflows and consequently is deposited on the part where covering layer remains unremoved. Accordingly, an overly high accuracy is not required of the dispenser or the like, and, thus, the limitation on the production equipment is reduced.

In this case, when the supply of the electrically conductive material-containing composition by a dispenser or the like is difficult, for example, due to narrow width of the covering layer-removed part, a liquid reservoir for supplying the electrically conductive material-containing composition may be previously formed in the pattern. FIG. 4 is a three-dimensional cross-sectional view showing an embodiment of a pattern provided with the liquid reservoir. When an electrically conductive material-containing composition is supplied to a liquid reservoir 8 formed on the photosensitive resin composition layer, the electrically conductive material-containing composition is developed into the covering layer-removed part connected to the liquid reservoir 8. The shape of the liquid reservoir may be as shown in FIG. 5.

Wirings formed of different electrically conductive material-containing compositions may be formed on one substrate by adopting a method in which the electrically conductive material-containing composition is supplied by a dispenser to the pattern provided with the liquid reservoir 8.

Thus, the electrically conductive material-containing composition can be deposited in a desired shape to form a wiring pattern. If necessary, further treatment can be carried out to fix the electrically conductive material-containing composition. For example, the medium can be removed by heating to fix the electrically conductive material-containing composition as a wiring material. Further, a method may also be adopted in which an additive, which can be reacted with the electrically conductive material-containing composition to cure the electrically conductive material-containing composition upon heating or ultraviolet or electron beam irradiation, is incorporated into the electrically conductive material-containing composition followed by heating or the like for curing.

The wiring pattern thus formed may be used for various semiconductor devices. Specific examples of such semiconductor devices include transistors and light emitting diodes, and devices using them, for example, LSIs, flat panel displays, and color filters.

### EXAMPLES

### Example 1

A photosensitive resin composition PS-MSZ was spin coated on a silicon substrate, and the coating was prebaked at 110° C. for one min to form a 1.5 μm-thick film. Further, a fluoropolymer composition FS-1010 (manufactured by Fluoro Technology) was spin coated to form a 0.01 μm-thick surface covering film.

This sample was patterned using a stepper (LD-5050iw manufactured by Hitachi, Ltd.) to prepare a 10 μm-width trench pattern. Thereafter, the whole surface of the sample was exposed to ultraviolet light at an intensity of 100 mJ/cm², was exposed to a water vapor atmosphere of 25° C. and 80% RH for 2 min, and was then post-baked at 150° C. for 5 min.

The surface properties of this sample in its part in which the pattern stays was examined. As a result, it was found that the part in which the pattern stays was highly repellent to surfactant-containing aqueous solutions, and all of organic solvents of isopropyl alcohol, xylene, or propylene glycol monomethyl ether acetate and was not wetted thereby. In this case, the contact angle of n-hexadecane with the part in which the pattern stays as measured at 23° C. was 65 degrees. On the other hand, the pattern-removed part (inside of the trench) did not repel surfactant-containing aqueous solutions and organic solvents and was found to be lyophilic. The contact angle of n-hexadecane with the pattern-removed part as measured at 23° C. was 10 degrees.

### Example 2

An electrically conductive ink (hereinafter referred to as “copper electrically conductive ink”) was prepared by dispersing 10 g of copper nanoparticles in 90 g of decane. The copper electrically conductive ink was coated onto the pattern produced in Example 1 by a) spin coating, b) dip coating, c) spray coating, or d) slit coating. The contact angle of the copper electrically conductive ink as measured at 23° C. was 60 degrees with the part in which the pattern stayed, and was 10 degrees with the pattern-removed part.

In each case, the copper conductive ink was once spread-over the whole area of the pattern and was soon repelled by the part in which the pattern stayed, and consequently became ball-like shape. The copper electrically conductive ink in a ball-like shape could be removed by applying centrifuging force or an air stream to the pattern. On the other hand, the copper electrically conductive ink remaining within the trench stays uniformly within the trench even after the above operation.

### Comparative Example 1

A pattern was formed in the same manner as in Example 1, except that the fluoropolymer film was not formed. For this sample, the surface properties of the part in which the pattern stayed were examined. As a result, the part in which the pattern stayed was wetted by organic solvents and surfactant-containing aqueous solutions. In this case, the contact angle of n-hexadecane with the part in which the pattern stayed as measured at 23° C. was 20 degrees. When the copper electrically conductive ink was spin coated, the copper electrically conductive ink was spread over and deposited onto the whole area of the pattern and could not be removed by centrifuging force or air stream without difficulties.

### Example 3

In the same manner as in Example 1, a trench and a pattern having a liquid reservoir having a size of 1 mm×1 mm connected to the trench was produced. When a copper electrically conductive ink was delivered to this liquid reservoir by a precise dispenser, the copper electrically conductive ink flowed into the trench and could evenly cover the pattern-removed part. Further, when the copper electrically conductive ink was delivered to the part in which the pattern stayed, the copper electrically conductive ink was scattered in a ball form, and the copper electrically conductive ink upon touch with the trench flowed into the trench.

### Example 4

A pattern was formed in the same manner as in Example 1, except that a photosensitive acrylic resin composition (AZ RISOFINE OC-302 (tradename; AZ Electronic Materials) was used instead of PS-MSZ and the humidification treatment was omitted. For this pattern, the surface properties were examined in the same manner as in Example 1. As a result, the part in which the pattern stayed was repellent to surfactant-containing aqueous solutions and organic solvents, whereas the pattern-removed part was lyophilic to surfactant-containing aqueous solutions and organic solvents. The contact angle of n-hexadecane as measured at 23° C. was 55 degrees with the part in which the pattern stayed, and was 5 degrees with the pattern-removed part.

### Example 5

Silver nanoparticles (10 g) each having a surface coated with a surfactant were dispersed in 90 g of water to prepare a silver electrically conductive ink. A coating test was carried out by methods a) to d) in the same manner as in Example 2, except that this silver electrically conductive ink was used. Also when the silver electrically conductive ink was used, in the part where the pattern stayed, the ink became ball-like shape and was repelled by this part that is, this part was lyophobic, whereas, in the pattern-removed part, the ink was evenly spread. The contact angle of the silver electrically conductive ink as measured at 23° C. was 82 degrees with the part in which the pattern stayed and was 4 degrees with the pattern-removed part.

### Example 6

In the pattern prepared in Example 1, the pattern-removed part was filled with a silver electrically conductive ink by dip coating. Ball-like ink remaining on the surface was removed, followed by baking at 300° C. for 30 min. The resistance value of the embedded wiring thus obtained was measured and was found to be 3.5 μΩcm, that is, was good.

### Example 7

A photosensitive acrylic resin (AZ RISOFINE OC-302 (tradename) manufactured by AZ Electronic Materials) was spin coated onto a glass substrate to form a 3 μm-thick film which was then prebaked at 90° C. for one min. Separately, a solution of a fluoropolymer (Ftergent 110, manufactured by Neos Co., Ltd.) dissolved in a concentration of 2% in ethanol was prepared. The photosensitive acrylic resin-coated substrate was dipped in the fluoropolymer-ethanol solution and was pulled up, followed by measurement by ellipsospectroscopy. As a result, it was found that a 0.07 μm-thick fluoropolymer film was deposited.

The sample thus obtained was subjected to 8 μm patterning using a stepper and was post-baked at 150° C. The contact angle with this sample was measured. Specifically, the contact angle of n-hexadecane with the sample as measured at 23° C. was 55 degrees with the part in which the pattern stayed, and was not more than 5 degrees with the pattern-removed part.

1. A pattern comprising
a substrate,
a photosensitive resin composition layer formed on said substrate, and
a surface covering layer formed on said photosensitive resin composition layer, said photosensitive resin composition layer and said surface covering layer having been removed imagewise,
wherein contact angle of n-hexadecane with said surface covering layer as measured at 23° C. is not less than 41 degrees.

2. The pattern according to claim 1, wherein the contact angle of n-hexadecane with a part, of said pattern, from which said photosensitive resin composition layer and said surface covering layer have been removed as measured at 23° C. is not more than 40 degrees.

3. The pattern according to claim 1, wherein said surface covering layer comprises a fluorine-containing polymer.

4. The pattern according to claim 3, wherein said fluorine-containing polymer contains a perfluoroalkyl group having 1 to 18 carbon atoms.

5. The pattern according to claim 1, wherein said photosensitive resin composition layer is derived from a photosensitive resin composition comprising a polymer having a silazane structure, a photosensitizer, and a solvent.

6. A method for pattern formation, comprising the steps of:
forming a photosensitive resin composition layer on a substrate;
forming a surface covering layer on said photosensitive resin composition layer;
exposing said photosensitive resin composition layer imagewise; and
developing the assembly to remove said photosensitive resin composition layer and said surface covering layer in their exposed areas,
wherein contact angle of n-hexadecane with said surface covering layer as measured at 23° C. is not less than 41 degrees.

7. A method for wiring pattern fabrication comprising the steps of:
forming a photosensitive resin composition layer on a substrate;
forming a surface covering layer on said photosensitive resin composition layer;
exposing said photosensitive resin composition layer imagewise;
developing the assembly to remove said photosensitive resin composition layer and said surface covering layer in their exposed areas; and
depositing an electrically conductive material-containing composition only on the part from which the covering has been removed by the development,
wherein contact angle of said electrically conductive material-containing composition with the surface covering layer as measured at 23° C. is not less than 41 degrees.

8. The process for producing a wiring pattern according to claim 7, wherein said electrically conductive material-containing composition comprises metal fine particles and a solvent.

9. The process for producing a wiring pattern according to claim 7, wherein, after the deposition of said electrically conductive material-containing composition, said electrically conductive material-containing composition is cured by heating or ultraviolet or electron beam irradiation.

10. A semiconductor device comprising a wiring pattern, said wiring pattern has been produced by a method comprising the steps of:
forming a photosensitive resin composition layer on a substrate;
forming a surface covering layer on said photosensitive resin composition layer;
exposing said photosensitive resin composition layer imagewise;
developing the assembly to remove said photosensitive resin composition layer and said surface covering layer in their exposed areas; and
depositing an electrically conductive material-containing composition only on the part from which the covering has been removed by the development,
wherein contact angle of said electrically conductive material-containing composition with said surface covering layer as measured at 23° C. is not less than 41 degrees.

11. The pattern according to claim 6, wherein said surface covering layer comprises a fluorine-containing polymer.

12. The pattern according to claim 6, wherein said fluorine-containing polymer contains a perfluoroalkyl group having 1 to 18 carbon atoms.

13. The pattern according to claim 1, wherein said photosensitive resin composition layer is derived from a photosensitive resin composition comprising a polymer having a silazane structure, a photosensitizer, and a solvent.

14. The method according to claim 7, wherein said surface covering layer comprises a fluorine-containing polymer.

15. The method according to claim 7, wherein said fluorine-containing polymer contains a perfluoroalkyl group having 1 to 18 carbon atoms.

16. The method according to claim 7, wherein said photosensitive resin composition layer is derived from a photosensitive resin composition comprising a polymer having a silazane structure, a photosensitizer, and a solvent.

17. The device according to claim 10, wherein said surface covering layer comprises a fluorine-containing polymer.

18. The device according to claim 10, wherein said fluorine-containing polymer contains a perfluoroalkyl group having 1 to 18 carbon atoms.

19. The device according to claim 10, wherein said photosensitive resin composition layer is derived from a photosensitive resin composition comprising a polymer having a silazane structure, a photosensitizer, and a solvent.

20. The device according to claim 10, wherein said electrically conductive material-containing composition comprises metal fine particles and a solvent.

21. The device according to claim 10, wherein, after the deposition of said electrically conductive material-containing composition, said electrically conductive material-containing composition is cured by heating or ultraviolet or electron beam irradiation.
